(19) United States
(12) Patent Application Publication
(10) Pub. No.: US 2024/0141522 A1
(43) Pub. Date: May 2, 2024

(54) WATER ELECTROLYSIS SYSTEM

(71) Applicant: TOYOTA JIDOSHA KABUSHIKI KAISHA, Toyota-shi (JP)

(72) Inventor: Kohsei YOSHIDA, Gotenba-shi (JP)

(73) Assignee: TOYOTA JIDOSHA KABUSHIKI KAISHA, Toyota-shi (JP)

(21) Appl. No.: 18/455,034

(22) Filed: Aug. 24, 2023

(30) Foreign Application Priority Data
Nov. 1, 2022 (JP) 2022-175288

(51) Int. Cl. C25B 15/023; C25B 1/04; C25B 15/08

(52) U.S. Cl. CPC C25B 15/023; C25B 1/04; C25B 15/08

(57) ABSTRACT

In the water electrolysis system, the water electrolysis system includes a water electrolysis cell stack and a reaction water supply device, and the water electrolysis system gradually increases the supply amount of the reaction water to the oxygen electrode by the reaction water supply device so that a pressure value on an oxygen electrode side of the water electrolysis cell stack does not become higher than a pressure value on a hydrogen electrode side of the water electrolysis cell stack when the water electrolysis system is activated.

### CROSS-REFERENCE TO RELATED APPLICATION

This application claims priority to Japanese Patent Application No. 2022-175288 filed on Nov. 1, 2022, incorporated herein by reference in its entirety.

### BACKGROUND

### 1. Technical Field

The present disclosure relates to a water electrolysis system.

### 2. Description of Related Art

Various studies have been made on water electrolysis devices. For example, Japanese Unexamined Patent Application Publication No. 2017-210646 (JP 2017-210646 A) discloses a water electrolysis device in which an end portion of an anode electrode catalyst layer and an end portion of a cathode electrode catalyst layer are disposed at positions different from each other when viewed in a thickness direction of an electrolyte membrane.

### SUMMARY

In the related art, a problem arises in that the structure corresponds to a state in which a hydrogen electrode pressure is higher than an oxygen electrode pressure and this may be, in terms of structure, disadvantageous for a reverse differential pressure at the time of activation.

The present disclosure has been made in view of the above circumstances, and a main object thereof is to provide a water electrolysis system capable of suppressing generation of a reverse differential pressure when the water electrolysis system is activated.

The present disclosure provides a water electrolysis system that includes a water electrolysis cell stack and a reaction water supply device. A supply amount of reaction water to an oxygen electrode by the reaction water supply device is gradually increased such that a pressure value on the oxygen electrode side of the water electrolysis cell stack is not higher than a pressure value on a hydrogen electrode side of the water electrolysis cell stack when the water electrolysis system is activated.

In the present disclosure, the water electrolysis system may further include an oxygen electrode side bypass flow path. The oxygen electrode side bypass flow path may connect an oxygen electrode side inlet flow path and an oxygen electrode side outlet flow path such that the reaction water makes a detour from the water electrolysis cell stack. A flow rate control valve may be disposed in the oxygen electrode side bypass flow path. The flow rate control valve may control the pressure value on the oxygen electrode side not to be higher than the pressure value on the hydrogen electrode side.

In the present disclosure, the water electrolysis system may further include a control unit, an oxygen electrode side pressure sensor, and a hydrogen electrode side pressure sensor. The oxygen electrode side pressure sensor may measure the pressure value on the oxygen electrode side. The hydrogen electrode side pressure sensor may measure the pressure value on the hydrogen electrode side. The control unit may gradually increase the supply amount of the reaction water to the oxygen electrode by the reaction water supply device such that the pressure value on the oxygen electrode side measured by the oxygen electrode side pressure sensor is not higher than the pressure value on the hydrogen electrode side measured by the hydrogen electrode side pressure sensor when the water electrolysis system is activated.

In the present disclosure, the water electrolysis system may further include an oxygen electrode side bypass flow path, a control unit, an oxygen electrode side pressure sensor, and a hydrogen electrode side pressure sensor. The oxygen electrode side bypass flow path may connect an oxygen electrode side inlet flow path and an oxygen electrode side outlet flow path such that the reaction water makes a detour from the water electrolysis cell stack. A flow rate control valve may be disposed in the oxygen electrode side bypass flow path. The oxygen electrode side pressure sensor may measure the pressure value on the oxygen electrode side. The hydrogen electrode side pressure sensor may measure the pressure value on the hydrogen electrode side. The control unit may control the pressure value on the oxygen electrode side not to be higher than the pressure value on the hydrogen electrode side by the flow rate control valve when the water electrolysis system is activated.

The water electrolysis system according to the present disclosure can suppress generation of a reverse differential pressure at the time of activation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an example of a water electrolysis system of the present disclosure;

FIG. 2 is a schematic block diagram illustrating another embodiment of a water electrolysis system according to the present disclosure; and

FIG. 3 is a schematic configuration diagram illustrating another example of the water electrolysis system of the present disclosure.

### DETAILED DESCRIPTION OF EMBODIMENTS

Embodiments according to the present disclosure will be described below. It should be noted that matters other than those specifically mentioned in the present specification and necessary for the implementation of the present disclosure (for example, a general configuration and a manufacturing process of a water electrolysis system that does not characterize the present disclosure) can be understood as design matters of a person skilled in the art based on the prior art in the field. The present disclosure may be carried out based on the content disclosed in the present specification and the common general technical knowledge in the field. In the present specification, “to” indicating a numerical range is used in a sense including numerical values described before and after the numerical range as a lower limit value and an upper limit value. Any combination of the upper limit value and the lower limit value in the numerical range can be adopted.

The present disclosure provides a water electrolysis system that includes a water electrolysis cell stack and a reaction water supply device. A supply amount of reaction water to an oxygen electrode by the reaction water supply device is gradually increased such that a pressure value on the oxygen electrode side of the water electrolysis cell stack is not higher than a pressure value on a hydrogen electrode side of the water electrolysis cell stack when the water electrolysis system is activated.

During the stoppage of the water electrolysis, the generated hydrogen pressure is sealed at about atmospheric pressure in order to relieve stress on the sealing member. When the water electrolysis cell is started up, pure water necessary for water electrolysis is supplied to the water electrolysis cell by a pump in an amount necessary for hydrogen production. When a pump for supplying pure water is operated, the pure water pressure in the water electrolysis cell rapidly increases due to a pressure loss in the pure water flow path. Since the hydrogen pressure rises to a predetermined pressure due to the accumulation of the generated hydrogen, the pressure is low immediately after the start of the water electrolysis cell, and the hydrogen pressure is less than the pure water pressure (a pressure difference opposite to that in the normal state), and a differential pressure in the opposite direction is generated. Since it is assumed that hydrogen pressure>pure water pressure is used in the normal state, the water electrolysis cell is not supported in the reverse differential pressure direction.

In the present disclosure, the supply amount of the reaction water to the oxygen electrode by the reaction water supply device is gradually increased so that the pressure value on the oxygen electrode side of the water electrolysis cell stack does not become higher than the pressure value on the hydrogen electrode side of the water electrolysis cell stack when the water electrolysis system is activated. As a result, the hydrogen electrode pressure is always greater than the oxygen electrode pressure, and the reverse differential pressure generated before the hydrogen pressure increases can be avoided.

In the present disclosure, by providing the oxygen electrode side bypass flow path provided with the flow rate control valve, it is possible to improve the accuracy of the pressure adjustment without changing the flow rate of the reaction water supply device, and to suppress the generation of the reverse differential pressure.

The water electrolysis system of the present disclosure includes a water electrolysis cell stack and a reaction water supply device.

A water electrolysis cell stack (hereinafter sometimes referred to as a stack) is a laminate in which a plurality of water electrolysis cells are stacked. The number of stacked water electrolysis cells is not particularly limited, and may be, for example, 2 to several hundred. In the water electrolysis cell of the present disclosure, water supplied to an anode (oxygen electrode) is electrolyzed, oxygen is generated from the anode, and hydrogen is generated from the cathode (hydrogen electrode).

Anode: H₂O→2H⁺+½O₂2e⁻

Cathode: 2H⁺+2e⁻→H₂

The water electrolysis cell may include two separators having at least an electrode portion and sandwiching the electrode portion as necessary. The electrode portion includes an anode-side gas diffusion layer, an anode catalyst layer, an electrolyte membrane, a cathode catalyst layer, and a cathode-side gas diffusion layer in this order.

The cathode (hydrogen electrode) includes a cathode catalyst layer and a cathode-side gas diffusion layer. The anode (oxygen electrode) includes an anode catalyst layer and an anode-side gas diffusion layer.

The cathode catalyst layer and the anode catalyst layer are collectively referred to as a catalyst layer. The catalyst layer may include, for example, a catalyst metal that promotes water electrolysis, an electrolyte having proton conductivity, a support having electron conductivity, and the like. As the catalytic metal, for example, iridium (Ir), iridium dioxide (IrO₂), ruthenium (Ru), platinum (Pt), and an alloy composed of Pt and another metal (for example, a Pt alloy obtained by mixing cobalt, nickel, and the like) can be used. The anode catalyst layer may use, for example, Ir, IrO₂, and Ru as catalyst metals, and the cathode catalyst layer may use, for example, Pt, and Pt alloys as catalyst metals. The electrolyte may be fluorine-based resin or the like. As the fluorine-based resin, for example, Nafion solution or the like may be used. The catalyst metal is supported on a carrier, and each catalyst layer may contain a mixture of a carrier supporting the catalyst metal (catalyst-supporting carrier) and an electrolyte. Examples of the carrier for supporting the catalyst metal include commercially available carbon materials such as carbon.

The electrolyte membrane may be a solid polymer electrolyte membrane. Examples of the solid polymer electrolyte membrane include fluorine-based electrolyte membranes such as perfluorosulfonic acid thin films containing water, and hydrocarbon-based electrolyte membranes. As the electrolyte membrane, for example, a Nafion membrane (produced by DuPont) may be used.

The cathode-side gas diffusion layer and the anode-side gas diffusion layer are collectively referred to as a gas diffusion layer (GDL). The gas diffusion layer may be a gas permeable, that is, a conductive member having pores. Examples of the electroconductive member include porous carbon bodies such as carbon cloth and carbon paper, and porous metal bodies such as metal mesh and metal foam.

The anode separator and the cathode separator are collectively referred to as a separator. The cathode separator is disposed adjacent to a surface of the cathode-side gas diffusion layer opposite to the cathode catalyst layer. The anode separator is disposed adjacent to a surface of the anode-side gas diffusion layer opposite to the anode catalyst layer. Two separators, an anode separator and a cathode separator, sandwich the resin frame and the electrode portion. The separator may have holes serving as manifolds such as supply holes and discharge holes for allowing fluids such as reaction water, oxygen, hydrogen, and a cooling medium to flow in the stacking direction of the water electrolysis cell. As the reaction water and the cooling medium, water, pure water, alkaline water, or the like can be used. Examples of the supply hole include an anode supply hole, a cathode supply hole, and a cooling medium supply hole. Examples of the discharge hole include an anode discharge hole, a cathode discharge hole, and a cooling medium discharge hole. The anode supply hole supplies the reaction water to the oxygen electrode. The anode discharge hole discharges oxygen generated by the water electrolysis from the oxygen electrode. The cathode supply hole may not be used during water electrolysis, and a cooling medium may be supplied to the hydrogen electrode. The cathode discharge hole discharges hydrogen generated by the water electrolysis from the hydrogen electrode. The cooling medium supply holes supply the cooling medium between the cells of the water electrolysis cell stack. The cooling medium discharge holes discharge the cooling medium from between the cells of the water electrolysis cell stack. The separator may have a flow path of a reaction fluid such as reaction water, oxygen, or hydrogen on a surface in contact with the gas diffusion layer. In addition, the separator may have a flow path of a cooling medium for keeping the temperature of the water electrolysis cell constant on the surface opposite to the surface in contact with the gas diffusion layer. The anode separator may have a flow path of an anode fluid such as reactive water or oxygen on a surface in contact with the anode-side gas diffusion layer. In addition, the anode separator may have a flow path of a cooling medium for keeping the temperature of the water electrolysis cell constant on the surface opposite to the surface in contact with the anode-side gas diffusion layer. The cathode separator may have a flow path of a cathode fluid such as hydrogen on a surface in contact with the cathode-side gas diffusion layer. In addition, the cathode separator may have a flow path of a cooling medium for keeping the temperature of the water electrolysis cell constant on the surface opposite to the surface in contact with the cathode-side gas diffusion layer. The separator may be a gas-impermeable electroconductive member or the like. The gas-impermeable conductive member may be, for example, dense carbon obtained by compressing a resin material such as a thermosetting resin, a thermoplastic resin, and a resin fiber, and a carbon material such as a carbon powder and a carbon fiber to make it gas-impermeable, or a press-molded metal (for example, titanium, stainless steel, or the like) plate. The shape of the separator may be a rectangle, a horizontally long hexagon, a horizontally long octagon, a circle, an oblong shape, and the like.

The water electrolysis cell may typically comprise a resin frame. The resin frame is disposed on the outer periphery of the electrode portion and is disposed between the cathode separator and the anode separator. The resin frame may have a framework portion, an opening portion, and a hole. The skeleton portion is a main portion of the resin frame connected to the electrode portion. The opening portion is a holding region of the electrode portion, and is a region penetrating a part of the skeleton portion for accommodating the electrode portion. The opening portion may be disposed at a position where the skeleton portion is disposed in the periphery (outer peripheral portion) of the electrode portion in the resin frame, and may be provided at the center of the resin frame. The holes of the resin frame allow a fluid such as reaction water, oxygen, hydrogen, and a cooling medium to flow in the stacking direction of the water electrolysis cell. The holes in the resin frame may be aligned and arranged to communicate with the holes in the separator. The resin frame may include a frame-shaped core layer and two frame-shaped shell layers provided on both sides of the core layer, that is, a first shell layer and a second shell layer. The first shell layer and the second shell layer may be provided in a frame shape on both sides of the core layer, similarly to the core layer.

The core layer may be a structural member having a gas sealing property and an insulating property, and may be formed of a material whose structure does not change even under a temperature condition at the time of thermocompression bonding in the manufacturing process of the water electrolysis cell. Specifically, the material of the core-layer may be, for example, a resin such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyether sulfone (PES), U-polyphenyl sulfone (PPS), liquid crystal polymer (LCP), or epoxy resin. The core-layer material may be a rubber material such as ethylene propylene diene rubber (EPDM), fluorine-based rubber, or silicone-based rubber. The thickness of the core layer may be 5 μm or more or 20 μm or more from the viewpoint of ensuring insulation. The thickness of the water core layer may be 200 μm or less or 150 μm or less from the viewpoint of reducing the electrolysis cell thickness.

The first shell layer and the second shell layer may have a high adherence property to other materials, have a property of softening under a temperature condition during thermocompression bonding and having a lower viscosity and melting point than the core layer, in order to adhere the core layer with the anode separator and the cathode separator and ensure a sealing performance. Specifically, the first shell layer and the second shell layer may be a thermoplastic resin such as a polyester-based thermoplastic resin and a modified olefin-based thermoplastic resin, or may be a thermosetting resin that is a modified epoxy resin. The resin that constitutes the first shell layer and the resin that constitutes the second shell layer may be the same type of resin or different types of resin. By providing the shell layers on both sides of the core layer, it becomes easier to adhere the resin frame and the two separators by hot pressing. The thickness of the shell layer of each of the first shell layer and the second shell layer may be 5 μm or more or 30 μm or more from the viewpoint of ensuring adhesion. The thickness of the shell layer of each of the first shell layer and the second shell layer may be 100 μm or less or 40 μm or less from the viewpoint of reducing the thickness of the water electrolysis cell.

In the resin frame, the first shell layer and the second shell layer may be provided only on the portions to be adhered to the anode separator and the cathode separator, respectively. The first shell layer provided on one side of the core layer may be adhered to the cathode separator. The second shell layer provided on the other side of the core layer may be adhered to the anode separator. Then, the resin frame may be sandwiched between the pair of separators.

In the water electrolysis cell stack, a sealing member such as a gasket or a resin sheet may be disposed between the water electrolysis cells so as to surround each hole and ensure a gas sealing property.

The water electrolysis cell stack may include a manifold such as an inlet manifold in which the supply holes communicate with each other and an outlet manifold in which the discharge holes communicate with each other. Inlet manifolds include anode inlet manifolds, cathode inlet manifolds, and cooling medium inlet manifolds. Outlet manifolds include anode outlet manifolds, cathode outlet manifolds, and cooling medium outlet manifolds. The anode inlet manifold and the anode outlet manifold are collectively referred to as an anode manifold. The cathode inlet manifold and the cathode outlet manifold are collectively referred to as a cathode manifold. The coolant inlet manifold and the coolant outlet manifold are collectively referred to as a coolant manifold.

The reaction water supply device supplies reactive water such as water, pure water, and alkaline water to the water electrolysis cell stack. The reaction water supply device may include a reaction water storage tank, a reaction water pump, and the like. The reaction water supply device is electrically connected to the control unit. The control unit controls the operation of the reaction water supply device and controls the flow rate of the reaction water supplied to the water electrolysis cell stack.

The water electrolysis system of the present disclosure may further include an oxygen electrode side bypass flow path. The oxygen electrode side bypass flow path connects the oxygen electrode side inlet flow path and the oxygen electrode side outlet flow path so that the reaction water bypasses the water electrolysis cell stack. A flow rate control valve is disposed in the oxygen electrode side bypass flow path. The control unit may control the flow rate control valve so that the pressure value on the oxygen electrode side is not higher than the pressure value on the hydrogen electrode side. The flow control valve is electrically connected to the control unit. The control unit controls the opening and closing of the flow rate control valve, and controls the flow rate of the reaction water supplied to the water electrolysis cell stack.

The water electrolysis system of the present disclosure may further include a control unit, an oxygen electrode side pressure sensor, and a hydrogen electrode side pressure sensor. The oxygen electrode side pressure sensor is disposed on the oxygen electrode side inlet flow path, and measures a pressure value on the oxygen electrode side. The oxygen electrode side pressure sensor is electrically connected to the control unit. The control unit detects a pressure value on the oxygen electrode side acquired by the oxygen electrode side pressure sensor. The hydrogen electrode side pressure sensor is disposed on a hydrogen extraction channel to be described later, and measures a pressure value on the hydrogen electrode side. The hydrogen electrode side pressure sensor is electrically connected to the control unit. The control unit detects a pressure value on the hydrogen electrode side acquired by the hydrogen electrode side pressure sensor. The oxygen electrode side pressure sensor and the hydrogen electrode side pressure sensor are collectively referred to as a pressure sensor. As the pressure sensor, a conventionally known pressure gauge or the like can be used. When the water electrolysis system is started up, the control unit may gradually increase the supply amount of the reaction water to the oxygen electrode by the reaction water supply device so that the pressure value on the oxygen electrode side measured by the oxygen electrode side pressure sensor does not become higher than the pressure value on the hydrogen electrode side measured by the hydrogen electrode side pressure sensor.

The control unit controls a flow rate of the reaction water supplied to the water electrolysis cell stack. The control unit controls the operation of the water electrolysis cell stack. The control unit physically includes, for example, an arithmetic processing unit such as a central processing unit (CPU), a read-only memory (ROM) that stores control programs processed by CPU, control data, and the like, a storage device such as a random access memory (RAM) that is mainly used as various working areas for the control processing, and an input/output interface. The control unit may be, for example, a control device such as Electronic Control Unit (ECU).

The water electrolysis system may have a reactive water system and a hydrogen system.

The reaction water system may include the above-described reaction water supply device, the above-described oxygen electrode side inlet flow path, the oxygen electrode side outlet flow path, the above-described oxygen electrode side bypass flow path, the above-described oxygen electrode side pressure sensor, the oxygen discharge flow path, etc. The oxygen electrode side inlet flow path connects the reaction water supply device and the oxygen electrode of the water electrolysis cell stack, specifically, the anode inlet manifold. The reaction water supply device supplies water, pure water, and the like to the oxygen electrode of the water electrolysis cell stack via the oxygen electrode side inlet flow path. In the oxygen electrode side inlet flow path, a flow rate control valve may be disposed downstream of the reaction water supply device. The oxygen electrode side outlet flow path may connect the oxygen electrode of the water electrolysis cell stack and the anode outlet manifold, and may discharge unreacted reacted water discharged from the water electrolysis cell stack, oxygen-containing gas generated by the water electrolysis, or the like to the outside of the water electrolysis system. The oxygen electrode side outlet flow path may connect the water electrolysis cell stack and the reaction water supply device, and recover unreacted reaction water or the like discharged from the water electrolysis cell stack to the reaction water supply device. The oxygen-containing gas may be oxygen, air, or the like.

The hydrogen system may include a hydrogen storage tank, a hydrogen extraction channel, the above-described hydrogen electrode side pressure sensor, a hydrogen relief valve, and the like. The hydrogen storage tank stores hydrogen generated by water electrolysis. The hydrogen extraction channel may connect the hydrogen storage tank and the hydrogen electrode of the water electrolysis cell stack, specifically, the cathode outlet manifold, and store the hydrogen discharged from the hydrogen electrode by the water electrolysis of the water electrolysis cell stack in the hydrogen storage tank. The hydrogen relief valve is disposed on the hydrogen extraction channel, and opens the valve when an abnormality is detected, and discharges hydrogen to the outside of the water electrolysis system. The hydrogen relief valve is electrically connected to the control unit. The control unit controls opening and closing of the hydrogen relief valve.

### First Embodiment

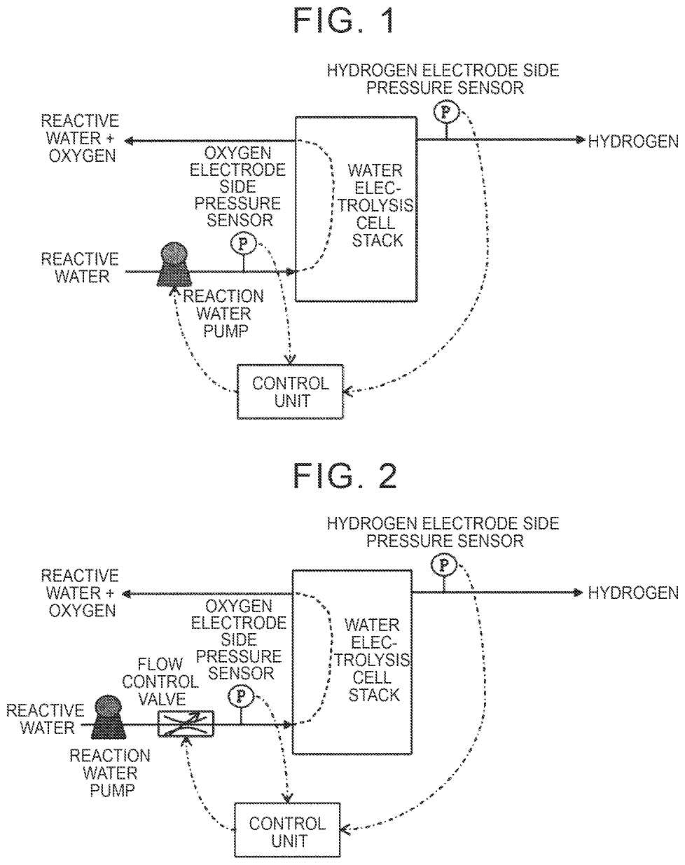

FIG. 1 is a schematic configuration diagram illustrating an example of a water electrolysis system of the present disclosure. Note that the water electrolysis system of the present disclosure is not limited to the configuration shown in FIG. 1. The water electrolysis system shown in FIG. 1 includes a water electrolysis cell stack, a control unit, a hydrogen electrode side pressure sensor, an oxygen electrode side pressure sensor, a reaction water pump, an oxygen electrode side inlet channel, an oxygen electrode side outlet channel, and a hydrogen extraction channel. A reaction water pump and an oxygen electrode side pressure sensor are arranged in this order from the upstream side in the oxygen electrode side inlet flow path. A hydrogen electrode side pressure sensor is disposed in the hydrogen extraction flow path. The water electrolysis system shown in FIG. 1 performs the following control.
1. The hydrogen electrode side pressure sensor value and the oxygen electrode side pressure sensor value are taken into the control unit from the respective pressure sensors.
2. The flow rate of the reaction water pump is controlled so that “hydrogen pressure sensor value>reaction water pressure sensor value” is always obtained, and the reaction water pressure in the water electrolysis cell stack is controlled. The control of the flow rate of the reaction water pump may control the rotational speed of the reaction water pump or may control the voltage applied to the reaction water pump.

### Second Embodiment

FIG. 2 is a schematic configuration diagram illustrating another example of the water electrolysis system of the present disclosure. In FIG. 2, description of the same configuration as in FIG. 1 will be omitted. In the water electrolysis system shown in FIG. 2, a flow rate control valve is disposed downstream of the reaction water pump in the oxygen electrode side inlet flow path. The water electrolysis system shown in FIG. 2 performs the following control.
1. The hydrogen electrode side pressure sensor value and the oxygen electrode side pressure sensor value are taken into the control unit from the respective pressure sensors.
2. The flow rate of the reaction water pump is controlled by a flow rate control valve so that “hydrogen pressure sensor value>reaction water pressure sensor value” is always obtained, and the reaction water pressure in the water electrolysis cell stack is controlled. The flow rate control valve may be a flow rate valve, a solenoid valve, or the like.

### Third Embodiment

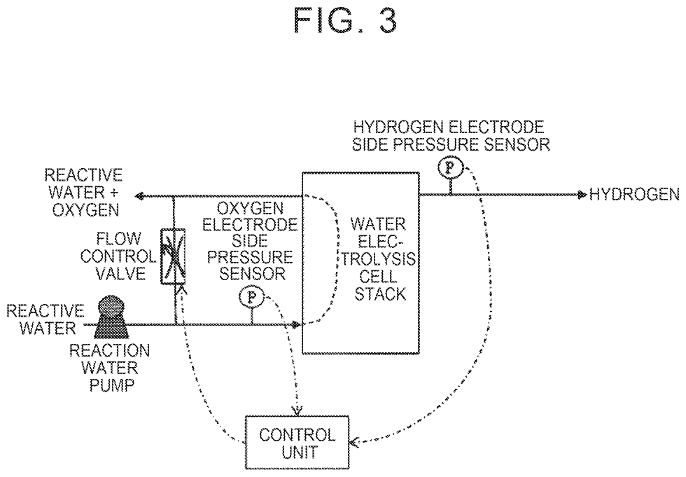

FIG. 3 is a schematic configuration diagram illustrating another example of the water electrolysis system of the present disclosure. In FIG. 3, description of the same configuration as in FIG. 1 will be omitted. The water electrolysis system shown in FIG. 3 has an oxygen electrode side bypass flow path connecting the oxygen electrode side inlet flow path and the oxygen electrode side outlet flow path so that the reaction water bypasses the water electrolysis cell stack, and a flow rate control valve is disposed in the oxygen electrode side bypass flow path. The water electrolysis system shown in FIG. 3 performs the following control.
1. The hydrogen-side pressure sensor value and the oxygen-side pressure sensor value are taken into the control unit from the respective pressure sensors.
2. The flow rate of the reaction water pump is not changed so that the hydrogen pressure sensor value is always greater than the reaction water pressure sensor value, and the flow rate control valve is opened so that a part of the reaction water flows into the oxygen electrode side bypass flow path, thereby reducing the amount of the reaction water flowing into the water electrolysis cell stack and controlling the reaction water pressure in the water electrolysis cell stack.

What is claimed is:

1. A water electrolysis system comprising a water electrolysis cell stack and a reaction water supply device, wherein a supply amount of reaction water to an oxygen electrode by the reaction water supply device is gradually increased such that a pressure value on the oxygen electrode side of the water electrolysis cell stack is not higher than a pressure value on a hydrogen electrode side of the water electrolysis cell stack when the water electrolysis system is activated.

2. The water electrolysis system according to claim 1, further comprising an oxygen electrode side bypass flow path, wherein:
the oxygen electrode side bypass flow path connects an oxygen electrode side inlet flow path and an oxygen electrode side outlet flow path such that the reaction water makes a detour from the water electrolysis cell stack;
a flow rate control valve is disposed in the oxygen electrode side bypass flow path; and
the flow rate control valve controls the pressure value on the oxygen electrode side not to be higher than the pressure value on the hydrogen electrode side.

3. The water electrolysis system according to claim 1, further comprising a control unit, an oxygen electrode side pressure sensor, and a hydrogen electrode side pressure sensor, wherein:
the oxygen electrode side pressure sensor measures the pressure value on the oxygen electrode side;
the hydrogen electrode side pressure sensor measures the pressure value on the hydrogen electrode side; and
the control unit gradually increases the supply amount of the reaction water to the oxygen electrode by the reaction water supply device such that the pressure value on the oxygen electrode side measured by the oxygen electrode side pressure sensor is not higher than the pressure value on the hydrogen electrode side measured by the hydrogen electrode side pressure sensor when the water electrolysis system is activated.

4. The water electrolysis system according to claim 1, further comprising an oxygen electrode side bypass flow path, a control unit, an oxygen electrode side pressure sensor, and a hydrogen electrode side pressure sensor, wherein:
the oxygen electrode side bypass flow path connects an oxygen electrode side inlet flow path and an oxygen electrode side outlet flow path such that the reaction water makes a detour from the water electrolysis cell stack;
a flow rate control valve is disposed in the oxygen electrode side bypass flow path;
the oxygen electrode side pressure sensor measures the pressure value on the oxygen electrode side;
the hydrogen electrode side pressure sensor measures the pressure value on the hydrogen electrode side; and
the control unit controls the pressure value on the oxygen electrode side not to be higher than the pressure value on the hydrogen electrode side by the flow rate control valve when the water electrolysis system is activated.
